(19) United States
(12) Patent Application Publication
(10) Pub. No.: US 2008/0201192 A1
(43) Pub. Date: Aug. 21, 2008

(54) CALCULATION APPARATUS, PROGRAM, CALCULATION SYSTEM AND CALCULATION METHOD FOR PRODUCTION PLAN

(76) Inventors: Hidenori Ueno, Yokohama (JP); Hiroyuki Kaneko, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/021,490

(22) Filed: Jan. 29, 2008

(30) Foreign Application Priority Data
Feb. 19, 2007 (JP) 2007-038250

(51) Int. Cl. G06Q 10/00

(52) U.S. Cl. 705/8

(57) ABSTRACT

A technique that can make a flexible production plan adaptable to circumstances of a production request-issuing side.

A producible quantity calculation part performs Material Requirements Planning for obtaining a producible quantity and a possible production date, with respect to production request information that has at least one production request specifying a requested production quantity of a product, a requested production date, and a priority. If the producible quantity calculation part judges that a requested production quantity in one production request cannot be produced by the requested production date in that production request, then the producible quantity calculation part postpones the requested production date to a later date according to a plurality of methods, to obtain producible quantities and possible production dates. The producible quantity calculation part generates image data that display, in a table, the producible quantities and possible production dates obtained by the methods.

The present application claims a priority from Japanese application no. 2007-038250 filed on Feb. 19, 2007, the content of which is hereby incorporated by reference into this application.

### BACKGROUND OF THE INVENTION

The present invention relates to a technique associated with Material Requirements Planning for obtaining the producible quantity and the possible production date with respect to production request information.

A technique is known that employs Material Requirements Planning (hereinafter, referred to as MRP) for calculating a producible quantity with respect to a requested production quantity, in order to make a production plan.

For example, the technique described in Patent Document 1 calculates a producible quantity, and makes a production plan in which a shortage of a part does not occur since the requested production date is postponed to a later date (postponement processing) if there is a lack of a part in producing the requested quantity.

Patent Document 1: Japanese Un-examined Patent Application Laid-Open No. 2002-244717

The technique described in Patent Document 1 makes a production plan that does not cause a shortage of a part with respect to a production request. The producible quantity, however, is calculated on the basis of a specific method of postponement processing or a specific priority order, so that it is impossible to make a flexible production plan adaptable to the circumstances of the production request-issuing side.

Thus, an object of the present invention is to provide a technique that can make a flexible production plan adaptable to the circumstances of the production request-issuing side.

### SUMMARY OF THE INVENTION

To solve the above problem, the present invention provides a technique that can calculate producible quantities by employing a plurality of methods of postponement processing or kinds of priority order to make a plurality of production plans, and output those production plans in a tabular form.

For example, the present invention provides a calculation apparatus for performing Material Requirements Planning by receiving production request information that has at least one production request specifying a requested production quantity of a product, a requested production date and a priority, and by obtaining a producible quantity and a possible production date according to the priority, with respect to the production request information, wherein: the calculation apparatus comprises a control part that performs: postponement processing, in which a plurality of methods of postponing a requested production date to a later date are determined in advance in the Material Requirements Planning, each method being performed if it is judged that a requested production quantity in one production request cannot be produced by the requested production date in the one production request, and the Material Requirements Planning is performed with the requested production date changed to the later date in the one production request according to each of the plurality of methods, and processing of changing a requested production date in the one production request to a later date is repeated until all the requested production quantities in the one production request can be produced; and processing of generating image data that display, in a table, the producible quantities and the possible production dates calculated by the postponement processing for each of the methods with respect to the production request information.

According to the present invention, producible quantities are calculated according to a plurality of postponing methods and kinds of priority order, and a plurality of production plans are outputted in a tabular form. Thus, a production request-issuing side can select a suitable production plan out of a plurality of production plans.

### BRIEF DESCRIPTION OF THE DRAWINGS

FIG. 1 is a schematic diagram showing a calculation apparatus as a first embodiment of the present invention;

FIG. 2 is a schematic diagram showing a part table;

FIG. 3A is a schematic diagrams showing makeup of products X and Y;

FIG. 3B is a schematic diagrams showing makeup of products X and Y;

FIG. 4 is a schematic diagram showing a lead time table;

FIG. 5 is a schematic diagram showing an initial stock table;

FIG. 6 is a schematic diagram showing an incoming-stock table;

FIG. 7 is a schematic diagram showing a production plan table;

FIG. 8 is a schematic view showing a display image;

FIG. 9 is a schematic diagram showing a production request table;

FIG. 10 is a schematic diagram showing method information;

FIG. 11A is a schematic diagrams for explaining a postponing method 1;

FIG. 11B is a schematic diagrams for explaining a postponing method 1;

FIG. 12A is a schematic diagram for explaining a postponing method 2;

FIG. 12B is a schematic diagram for explaining a postponing method 2;

FIG. 13 is a schematic block diagram showing a computer;

FIG. 14 is a flowchart showing processing performed in the calculation apparatus;

FIG. 15 is a schematic diagram showing a calculation apparatus as a second embodiment of the present invention;

FIG. 16 is a schematic view showing a display image;

FIG. 17 is a flowchart showing processing performed in the calculation apparatus;

FIG. 18 is a schematic diagram showing a calculation apparatus as a third embodiment of the present invention;

FIG. 19 is a schematic view showing a display image;

FIG. 20 is a flowchart showing processing performed in the calculation apparatus; and

FIG. 21 is a schematic block diagram showing a calculation system 400.

### DETAILED DESCRIPTION

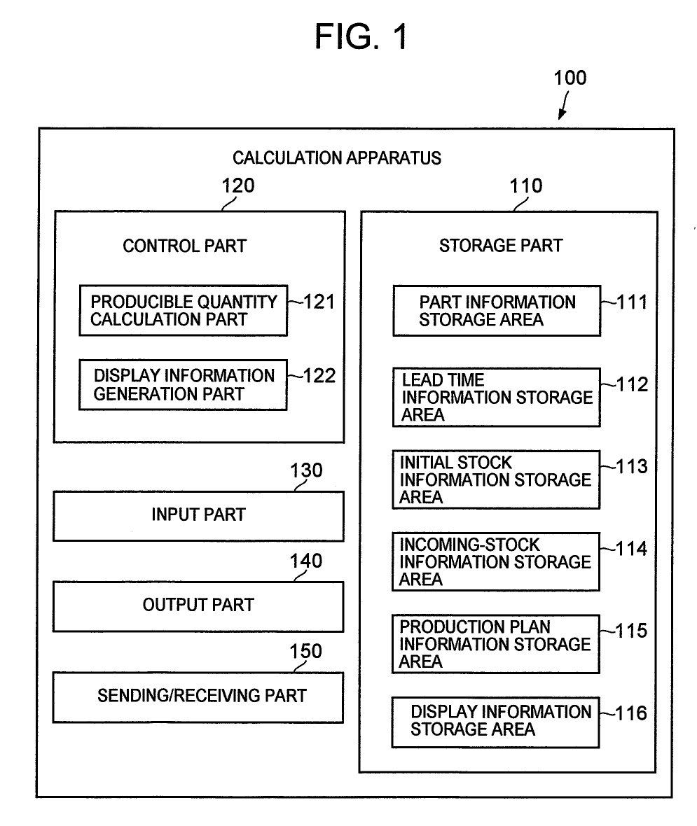

FIG. 1 is a schematic diagram showing a calculation apparatus 100 as a first embodiment of the present invention.

The calculation apparatus 100 comprises a storage part 110, a control part 120, an input part 130, an output part 140 and a sending/receiving part 150.

The storage part 110 comprises a part information storage area 111, a lead time information storage area 112, an initial stock information storage area 113, an incoming-stock information storage area 114, a production plan information storage area 115 and a display information storage area 116.

The part information storage area 111 stores information that specifies a part (i.e. an intermediate product or member) as a component of a product or another part and its quantity required to construct one unit of that product or part.

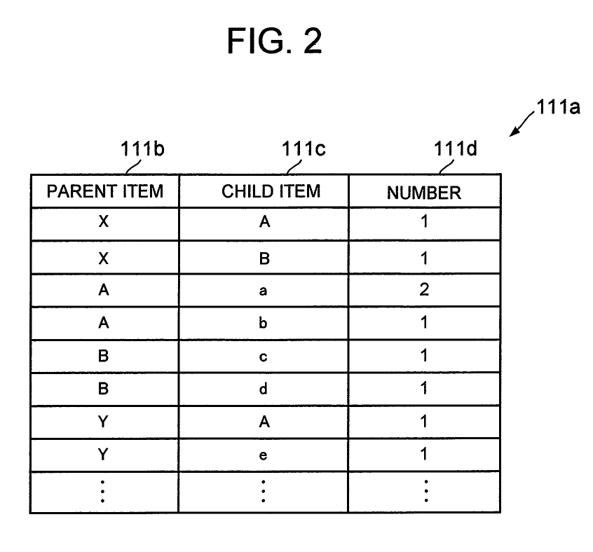

For example, the part information storage area 111 stores a part table 111a as shown in FIG. 2 (a schematic diagram showing the part table 111a).

The part table 111a has a parent item field 111b, a child item field 111c and a number field 111d.

The parent item field 111b stores information specifying a product or part, of which the part specified in the child item field 111c is a component member. Here, the parent item field 111b stores identification information (a name or an ID) that identifies a product or a part.

The child item field 111c stores information specifying a part (an intermediate product or member) that is a component member of the product or part specified in the parent item field 111b. Here, the child item field 111c stores identification information (a name or an ID) that identifies a part.

The number field 111d stores information specifying a required quantity of the part specified in the child item field 111c for constructing one unit of the product or part specified in the parent item field 111b.

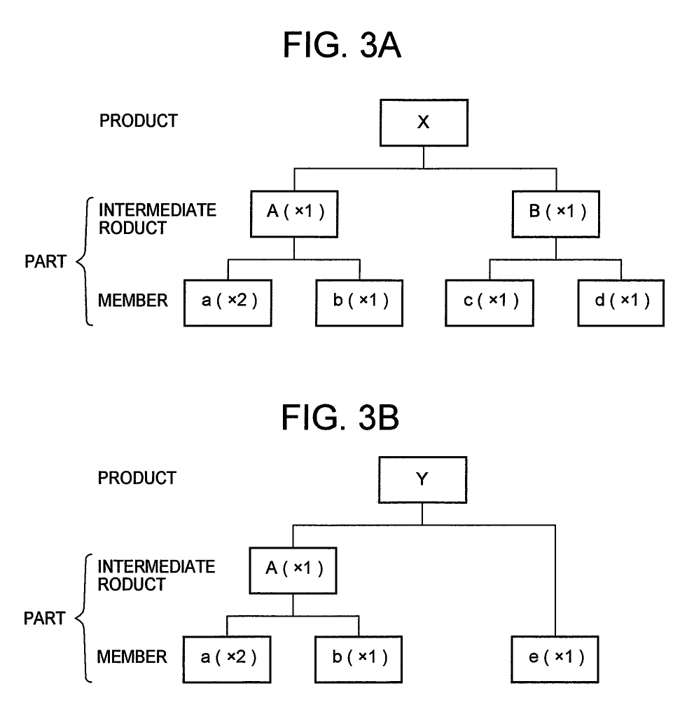

For example, in the present embodiment, as shown in FIG. 3 (a schematic diagram showing makeup of products X and Y), the product X is constructed by combining one intermediate product A and one intermediate product B. The intermediate product A is constructed by combining two members a, and one member b. Further, the intermediate product B is constructed by combining one member c, and one member d (see FIG. 3A).

Further, the product Y is constructed by combining one intermediate product A and one member e. As stated above, the intermediate product A is constructed by combining two members a, and one member b.

In the present embodiment, parts are intermediate products and members that constitute a product as the target of production. Each intermediate product is made by the producer of the product by combining members purchased from dealers, and used as a part of the final product. Further, each member is purchased by the producer of the product from a dealer and used as a part of the product or an intermediate product.

In the present embodiment, when identification information identifying the product X is stored in the parent item field 111b, then identification information identifying the intermediate product A or B is stored in the child item field 111c of the line corresponding to that parent item field 111b. For each of the intermediate products A and B, the corresponding number field 111d stores “1”.

Further, in cases where the identification information identifying the intermediate product A is stored in the parent item field 111b, the child item field 111c corresponding to that parent item field 111b stores identification information identifying the member a or b. The number field 111d corresponding to the member a stores “2”, and the number field 111d corresponding to the member b stores “1”.

Further, in cases where the identification information identifying the intermediate product B is stored in the parent item field 111b, the child item field 111c corresponding to that parent item field 111b stores identification information identifying the member c or d. For each of the members c and d, the corresponding number field 111d stores “1”.

Further, when identification information identifying the product Y is stored in the parent item field 111b, then identification information identifying the intermediate product A or the member e is stored in the child item field 111c of the line corresponding to that parent item field 111b. For each of the intermediate product B and the member e, the corresponding number field 111d stores “1”.

The lead time information storage area 112 stores information that specifies a production lead time of a product or a part or a procurement lead time of a part.

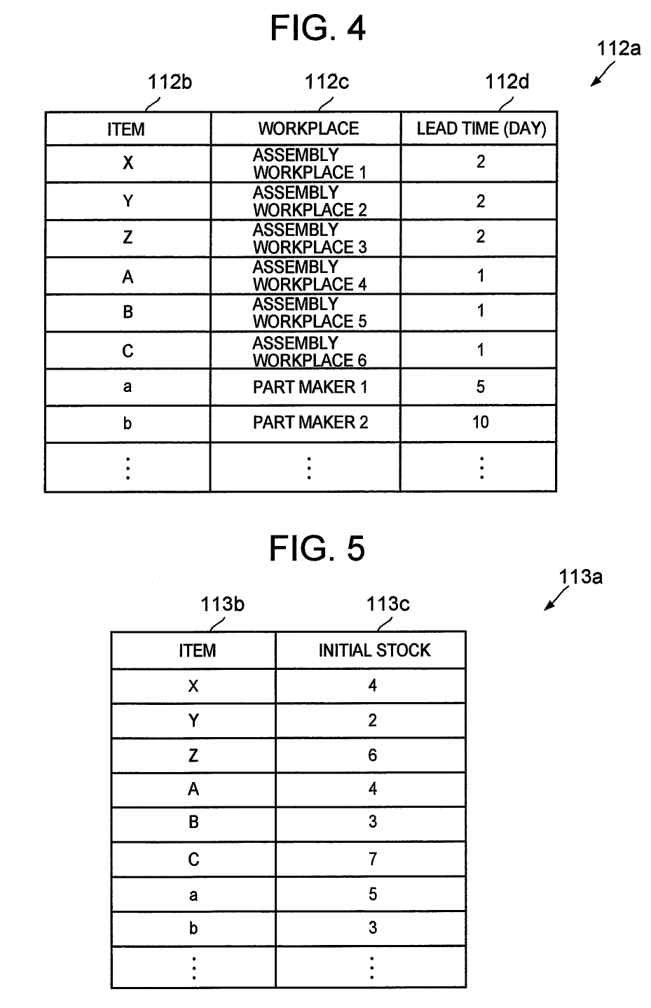

For example, the lead time information storage area 112 stores a lead time table 112a as shown in FIG. 4 (a schematic diagram showing the lead time table 112a).

The lead time table 112a has an item field 112b, a workplace field 112c and a lead time field 112d.

The item field 112b stores identification information that identifies a product or a part.

The workplace field 112c stores information that identifies a workplace in which the product or the part is produced in cases where the product or the part is produced, or a part maker from which the part is procured in cases where the part is procured from the outside.

The lead time field 112d stores a production lead time (i.e. a period from input of parts to completion) in cases where the product or the part is produced, or a procurement lead time (i.e. a period from order of the part to procurement) in cases where the part is procured. This field is expressed in units of days, although this mode is not restrictive.

The initial stock information storage area 113 stores information that specifies a quantity of a product or a part held in stock. In the present embodiment, this area 113 stores information indicating stock (initial stock) at the first date of a production plan calculated by the calculation apparatus 100.

For example, the initial stock information storage area 113 stores an initial stock table 113a as shown in FIG. 5 (a schematic diagram showing the initial stock table 113a).

The initial stock table 113a has an item field 113b and an initial stock field 113c.

The item field 113b stores identification information that identifies a product or a part.

The initial stock field 113c stores information that specifies a stock quantity (a quantity of an initial stock at the first date of a production plan calculated by the calculation apparatus 100) of the product or part specified in the item field 113b.

The incoming-stock information storage area 114 stores information that specifies an acceptance date and an incoming-stock quantity of a part procured from the outside.

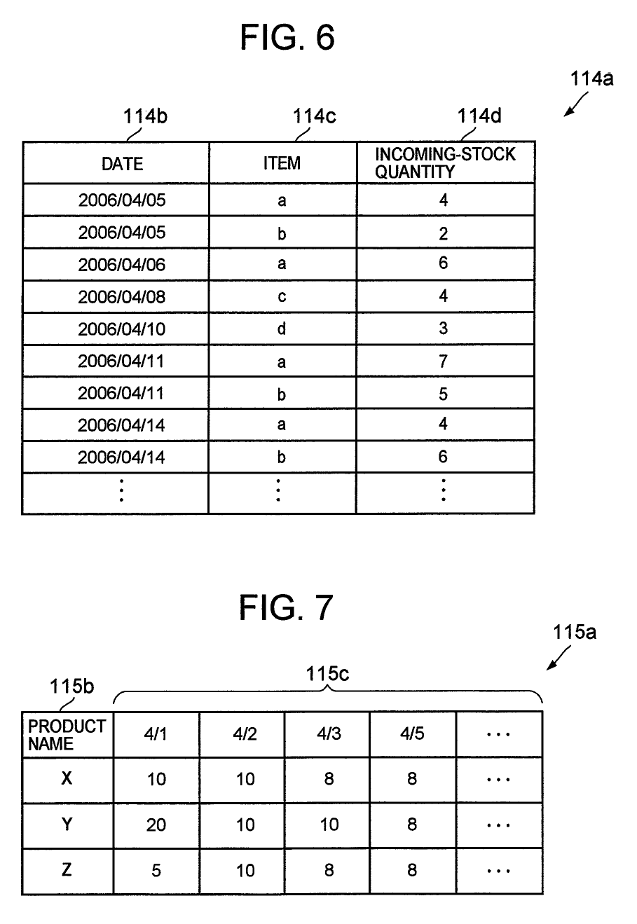

For example, the incoming-stock information storage area 114 stores an incoming-stock table 114a as shown in FIG. 6 (a schematic diagram showing the incoming-stock table 114a).

The incoming-stock table 114a has a date field 114b, an item field 114c and an incoming-stock quantity field 114d.

The date field 114b stores information that specifies an acceptance date of a part procured from the outside. In the present embodiment, information specifying year/month/day of receiving a new stock of a part is stored as the information specifying an acceptance date.

The item field 114c stores identification information that identifies the part procured from the outside.

The incoming-stock quantity field 114d stores an incoming-stock quantity of the part specified in the item field 114c, which is stored at the date specified in the date field 114b.

The production plan information storage area 115 stores information that specifies a production plan generated by the below-described producible quantity calculation part 121. Here, a production plan specifies the number of products that can be produced by a specific date at least for each product.

For example, the production plan information storage area 115 stores a production plan table 115a as shown in FIG. 7 (a schematic diagram showing the production plan table 115a) for each postponing method.

The production plan table 115a has a product name field 115b and a production plan field 115c.

The product name field 115b stores identification information that specifies a product. In the present embodiment, the product name field 115b stores a name of a product.

The production plan field 115c stores information that specifies dates and respective quantities producible at the dates for each product specified in the product name field 115b.

The display information storage area 116 stores display information generated in the below-described display information generation part 122. Here, display information provides, in a table, information that specifies the requested production quantity for each date, which is specified in the below-described production request information, and production quantity that is judged to be producible according to a specific postponing method for each product.

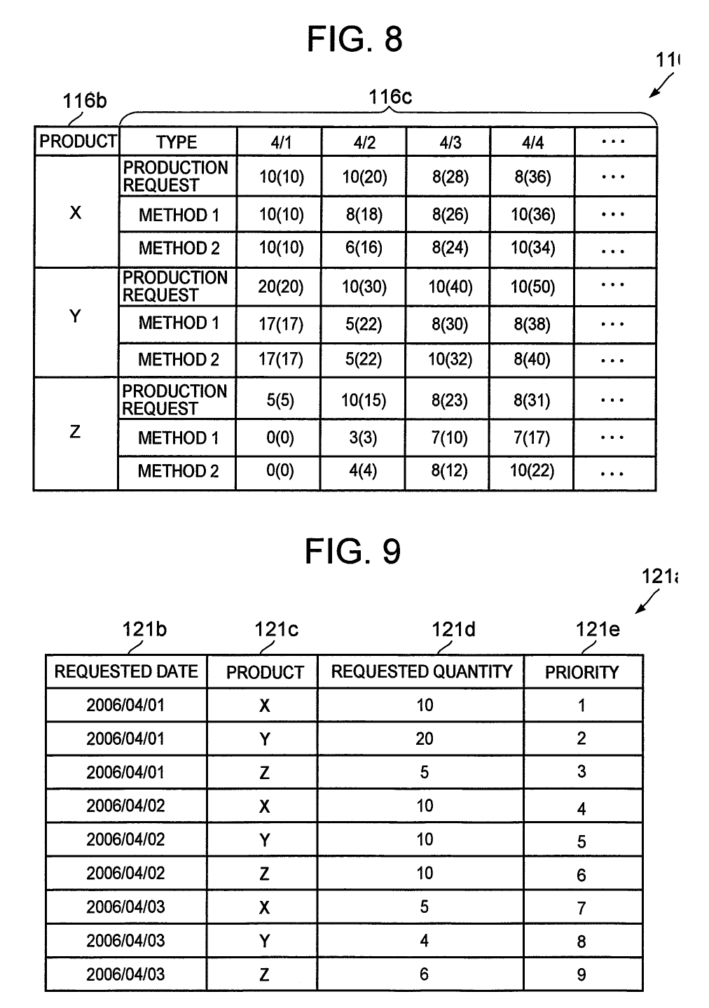

For example, the display information storage area 116 stores information that specifies a display image as shown in FIG. 8 (a schematic view showing the display image 116a).

The display image 116a has a product field 116b, a type field 116c and a production plan field 116d.

The product field 116b stores identification information that identifies a product. Here, a name of a product is stored as identification information.

The type field 116c stores identification information that identifies a production request or a postponing method. In the present embodiment, the type field 116c stores a character string “Production Request” in cases where the line concerned indicates requested production quantities. On the other hand, the type field 116c stores a character string “Method n” in cases where the line concerned indicates producible quantities calculated according to an n-th postponing method (n is a natural number, i.e. an identification number for identifying a postponing method).

The production plan field 116d stores requested production quantities or producible quantities by respective dates. That is, in a line in which the type field 116c stores the character string “Production Request”, the production plan field 116d stores requested production quantities by respective dates. On the other hand, in a line in which the type field 116c stores a character string “Method n”, the production plan field 116d stores quantities producible by respective dates.

Here, numbers in parentheses shown in the production plan field 116d indicate cumulative quantities.

The control part 120 comprises a producible quantity calculation part 121 and a display information generation part 122.

The producible quantity calculation part 121 performs MRP processing on the basis of production request information acquired through the below-described input part 130 or sending/receiving part 150.

It is assumed that the production request information required for performing the MRP processing includes at least a date at which a product is required, a requested quantity, and priority.

For example, in this regard, in the present embodiment, a production request table 121a as shown in FIG. 9 (a schematic diagram showing the production request table 121a) is inputted to the producible quantity calculation part 121 through the input part 130 or the sending/receiving part 150.

The production request table 121a has a requested date field 121b, a product field 121c, a requested quantity field 121d and a priority field 121e.

The requested date field 121b stores information that specifies a date at which a product specified in the below-described product field 121c is required. In the present embodiment, this field stores a date expressed as “year/month/day”, although this mode is not restrictive.

The product field 121c stores information that specifies identification information (a name or an ID) identifying a product whose production is requested.

The requested quantity field 121d stores information that specifies a quantity required by the date specified in the requested date field 121b with respect to the product specified in the product field 121c.

The priority field 121e stores information that specifies the priority of the production request specified in the line concerned. In the present embodiment, the priority field 121e stores a natural number, i.e. a sequential number starting from “1”, as the information specifying the priority, although this mode is not restrictive.

In the MRP processing performed by the producible quantity calculation part 121, a product, a requested date and a requested quantity are specified in the order of priority, referring to the priority field 121e of the production request table 121a.

The producible quantity calculation part 121 confirms the stock quantity of a product specified in the production request table 121a, referring to the initial stock table 113a. If there is a stock, the necessary and maximum quantity of the stock is allocated to cover the requested quantity, and the quantity of the allocated stock is subtracted from the initial stock table 113a. In cases where the requested quantity specified in the production request table 121a is all satisfied by the stock, the producible quantity calculation part 121 deals with the production request that is next in priority.

On the other hand, in cases where the requested quantity specified in the production request table 121a is not satisfied by the stock, the producible quantity calculation part 121 specifies the lead time of the product in question from the lead time table 112a. When the period from the current date to the requested date is longer than or equal to the lead time, parts of the product in question are specified from the part table 111a. On the other hand, when the period from the current date to the requested date is shorter than the lead time, the quantity that is not covered by the stock is specified.

Then, in cases where the period from the current date to the requested date is longer than or equal to the lead time, the producible quantity calculation part 121 allocates the stock of the parts specified in the part table 111a or the quantities of incoming-stocks of parts specified in the incoming-stock table 114a

For example, in cases where the period from the current date and the requested date is longer than or equal to the lead time, the producible quantity calculation part 121 specifies the stock of the parts (which are specified in the part table 111a) by the initial stock table 113a, and allocates the required quantities, and subtracts the allocated quantities from the initial stock table 113a. Here, in cases where all the stock concerned satisfy the quantities required for assembling the product, the producible quantity calculation part 121 deals with the production request that is next in priority.

On the other hand, in cases where not all the stock concerned satisfies the quantities required for assembling the product, the producible quantity calculation part 121 specifies whether the part in question is an intermediate product or a member by means of the part table 111a. When the part in question is a member, the producible quantity calculation part 121 specifies the acceptance date of the member in question by means of the incoming-stock table 114a. When the period from the acceptance date to the requested date is longer than (or equal to) the lead time of the product, the producible quantity calculation part 121 allocates the necessary and maximum quantity of the part in question and subtracts the allocated quantity from the incoming-stock table 114a. Here, in cases where all the incoming-stock quantities concerned satisfy the quantities required for assembling the product, the producible quantity calculation part 121 deals with the production request that is next in priority.

On the other hand, in cases where not all the incoming-stock quantities concerned satisfy the quantities required for assembling the product, the producible quantity calculation part 121 specifies the lead time of the member in question by means of the lead time table 112a. When the period from the current date to the requested date is longer than or equal to the lead time of the member, the producible quantity calculation part 121 deals with the production request that is next in priority.

On the other hand, in cases where the period from the current date to the requested date is shorter than the lead time of the member, the producible quantity calculation part 121 specifies the non-producible quantity of the product.

Further, in cases where not all the stock concerned satisfies the quantities required for assembling the product and the part in question (i.e. the part whose stock is deficient) is an intermediate product, then the producible quantity calculation part 121 specifies the lead time of the intermediate product in question from the lead time table 112a. When the period from the current date to the requested date is longer than (or equal to) the lead time of the intermediate product, the producible quantity calculation part 121 specifies the parts of the intermediate product in question from the part table 111a. On the other hand, when the period from the current date to the requested date is shorter than the lead time of the intermediate product, the producible quantity calculation part 121 specifies the non-producible quantity of the product.

Then, when the period from the current date to the requested date is longer than (or equal to) the lead time of the intermediate product, the producible quantity calculation part 121 specifies, from the initial stock table 113a, the stock of the parts specified by the part table 111a, and allocates the necessary and maximum quantities of the stock in question. The producible quantity calculation part 121 subtracts the allocated quantities from the initial stock table 113a. Here, in cases where all the stock concerned satisfies the quantities required for assembling the intermediate product, the producible quantity calculation part 121 deals with the production request that is next in priority.

On the other hand, in cases where not all the stock concerned satisfies the quantities required for assembling the intermediate product, the producible quantity calculation part 121 specifies whether the part in question is an intermediate product or a member, by means of the part table 111a, and repeats processing similar to the above-described processing.

In the above-described MRP processing, when there is a quantity that cannot be produced by the date specified by the production request information among the quantities specified by the production request information, the producible quantity calculation part 121 performs postponement processing according to a predetermined postponing method.

In the present embodiment, input of method information specifying a postponing method is received through the below-described input part 130 or sending/receiving part 150, and postponement processing according to the postponing method corresponding to the received method information is performed.

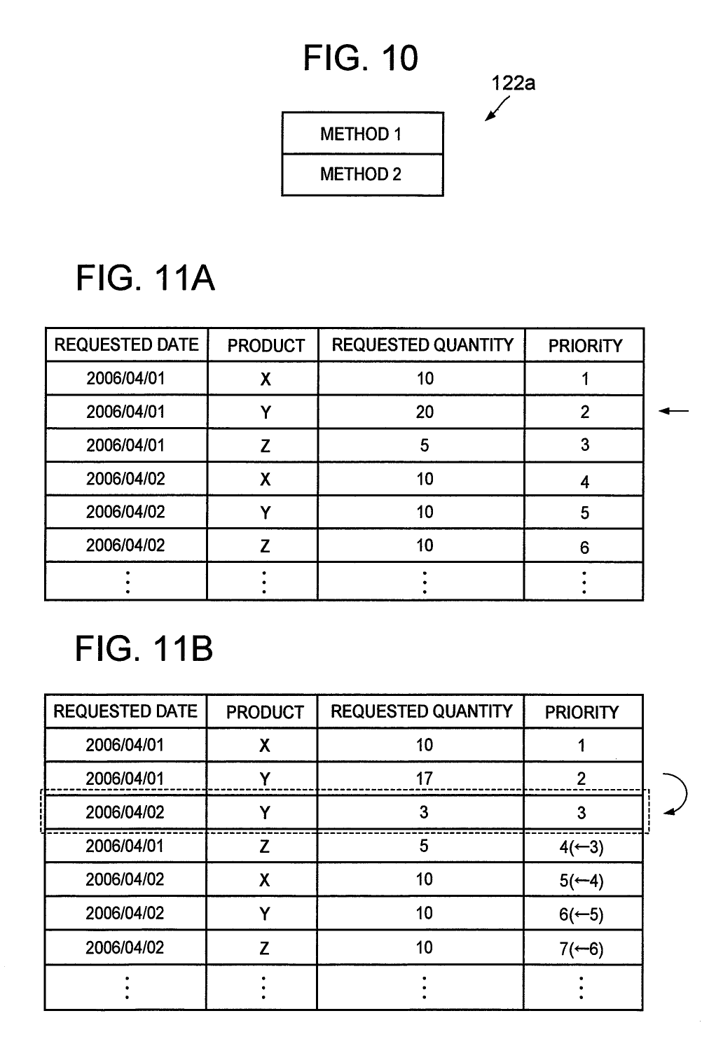

For example, in the present embodiment, as the method information received through the below-described input part 130 or sending/receiving part 150, method information 122a as shown in FIG. 10 (a schematic diagram showing the method information 122a) is inputted.

The method information 122a stores information that specifies identification information (a name or an ID) for identifying each postponing method.

As the postponing method, the present embodiment employs, for example, a method 1 or a method 2 described in the following.

FIG. 11 is a schematic diagram for explaining a postponing method 1.

Here, the postponing method 1 generates a new production request that is next in priority to the production request that has been judged to be non-producible. At that level of priority, the requested date for the requested quantity that has been judged to be non-producible is postponed step by step until the requested quantity becomes producible.

For example, with respect to the production request of priority “2” in the production request information shown in FIG. 11A, if the producible quantity calculation part 121 judges that only “17” can be produced out of the requested quantity “20”, then the producible quantity calculation part 121 generates a new production request that is next in priority (here, priority “3”) to the production request that has been judged to be non-producible, such that a new requested date is the date (here, “2006/04/02”) next to the requested date of the production request that has been judged to be non-producible, and a new requested quantity (here, “3”) is the original requested quantity that was judged to be non-producible, as in the production request information shown in FIG. 11B. Further, the priorities of the production requests that have lower priorities than the priority of the production request that has been judged to be non-producible, are each lowered by one.

With respect to the new production request information generated as described above, the producible quantity calculation part 121 performs the MRP processing again, to judge whether the newly-generated production request is producible. In cases where the new production request is producible, the producible quantity calculation part 121 proceeds to the production request that is next in priority. Otherwise, the producible quantity calculation part 121 postpones the requested date of the newly-generated production request further, to the next date.

The postponing method 1 repeats the above processing until all the production requests become producible.

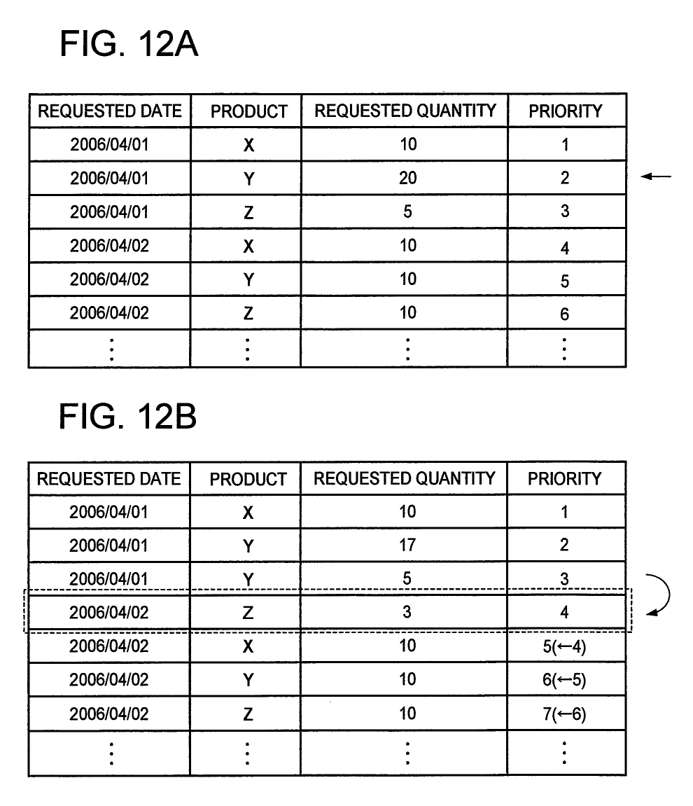

FIG. 12 is a schematic diagram for explaining a postponing method 2.

Here, the postponing method 2 generates a new production request such that its priority is highest among the production requests having the requested date next to the production request that has been judged to be non-producible, to produce the quantity which has been judged to be non-producible. If the new production request is judged to be non-producible at its requested date, a new production request is generated, having the highest priority among the production requests having the date next to that requested date.

For example, with respect to the production request of priority “2” in the production request information shown in FIG. 12A, if it is judged in the MRP processing that only “17” can be produced out of the requested quantity “20”, then the producible quantity calculation part 121 generates a new production request whose requested quantity is the quantity (here, “3”) that was originally judged to be non-producible, such that the priority of the new production request is highest among the production requests of the date (here, “2006/04/02”) next to the date of the original production request that has been judged to be non-producible, as in the production request information shown in FIG. 12B. Further, the priorities of the production requests that have lower priorities than the priority of the newly-generated production request, are each lowered by one.

With respect to the new production request information generated as described above, the producible quantity calculation part 121 performs the MRP processing again, to judge whether the newly-generated production request is producible. In cases where the newly-generated production request is non-producible, the producible quantity calculation part 121 repeatedly postpones the requested date by generating a new production request whose requested date is next to that date.

The postponing method 2 repeats the above processing until all the production requests become producible.

The postponing method is not limited to the above-described two methods. For example, it is possible that the method 1 is performed for a specific number of days and thereafter the method 2 is performed.

Information that specifies the producible quantities calculated by the postponement according to the method 1 or 2 is tabulated as in the production plan table 115a shown in FIG. 7 for each method, and stored in the production plan information storage area 115.

The display information generation part 122 generates a display image 116a as shown in FIG. 8 from the production request information and the production plan table 115a (stored in the production plan information storage area 115) generated by the producible quantity calculation part 121 based on the production request information. The generated display image 116a is stored in the display information storage area 116.

The display information generation part 122 also performs processing of outputting the generated display image 116a to the output part 140 in response to a request from the operator of the calculation apparatus 100, for example. Further, the display information generation part 122 also performs processing of sending the display image 116a through the sending/receiving part 150, for example.

The input part 130 is an input unit for inputting information.

The output part 140 is an output unit for outputting information.

The sending/receiving part 150 is a unit that sends and receives information through a network.

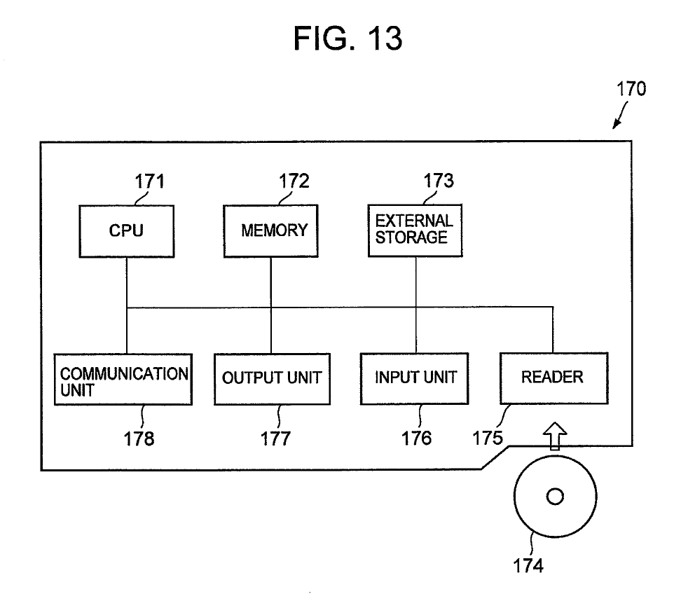

The above-described calculation apparatus 100 can be implemented by a computer 170 as shown in FIG. 13 (a schematic block diagram showing the computer 170).

The computer 170 comprises a CPU 171, a memory 172, an external storage 173 such as an HDD or the like, a reader 175 for reading out information from a portable storage medium 174 such as a CD-ROM, a DVD-ROM or the like, an input unit 176 such as a keyboard and a mouse, an output unit 177 such as a display, and a communication unit 178 such as a Network Interface Card (NIC) for connecting to a communication network.

For example, the storage part 110 can be implemented by the external storage 173. The control part 120 can be implemented when a prescribed program stored in the external storage 173 is loaded to the memory 172 and executed by the CPU 171. The sending/receiving part 150 can be implemented by the communication unit 178.

The prescribed program may be downloaded from the storage medium 174 though the reader 175 or from the network through the communication unit 178 into the external storage 173, and then loaded into the memory 172 and executed by the CPU 171. Alternatively, the prescribed program may be directly loaded from the network into the memory 172 though the communication unit 178, to be executed by the CPU 171.

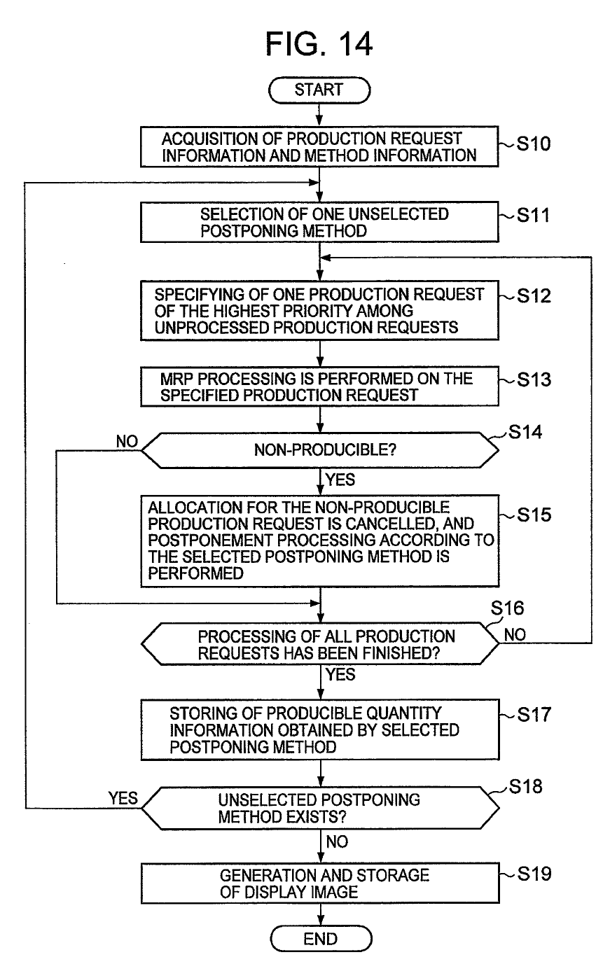

Processing performed by the calculation apparatus 100 of the above configuration will be described referring to the flowchart shown in FIG. 14.

First, the calculation apparatus 100 acquires the production request information and the method information through the input part 130 (S10).

Next, the producible quantity calculation part 121 of the calculation apparatus 100 selects one postponing method from the postponing method information acquired in step S10 (S11).

Next, the producible quantity calculation part 121 of the calculation apparatus 100 specifies one production request that has the highest priority among unprocessed production requests, from the production request information acquired in step S10 (S12).

The producible quantity calculation part 121 of the calculation apparatus 100 performs the MRP processing on the production request specified in step S12 (S13). If the specified requested quantity of the product cannot be produced by the designated requested date (S14), the processing flow goes to step S15. Otherwise, the processing flow goes to step S16.

In step S15, the allocation for the production request judged to be non-producible is cancelled. The producible quantity calculation part 121 of the calculation apparatus 100 performs the postponement processing according to the postponing method selected in step S11 (S15).

The producible quantity calculation part 121 of the control part 120 checks whether the processing of all the production requests in the production request information acquired in step S10 has been finished or not (S16). If the processing of all the production requests has not been finished, the processing flow returns to step S12 to repeat the processing.

If it is judged, in step S16, that the processing of all the production requests has been finished, then the producible quantity calculation part 121 of the control part 120 tabulates the results of the postponement processing into the production plan table 115a, and stores the production plan table 115a in the production plan information storage area 115 (S17).

The producible quantity calculation part 121 of the control part 120 judges whether there is an unselected postponing method among the postponing methods specified by the postponing method information acquired in step S10 (S18).

When it is judged, in step S18, that an unselected postponing method exists, then the processing flow returns to step S11 to repeat the processing. On the other hand, when it is judged that no unselected postponing method exists, then the display information generation part 122 of the control part 120 generates a display image 116a from the production request information acquired in step S10 and the production plan tables 115a, and stores the generated display image 116a in the display information storage area 116 (S19).

The display image 116a stored in this way can be outputted to the output part 140 or sent to another apparatus through the sending/receiving part, so that the display image 116a can be seen, for example, through a display or the like.

Since the display image 116a specifies production plans (producible quantities) according to a plurality of methods, it is possible to perform production according to a suitable production plan.

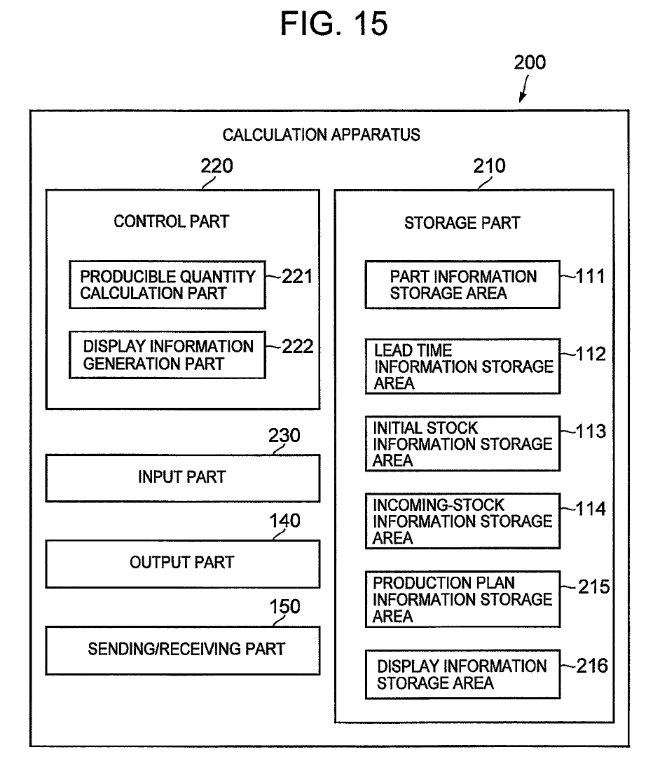

FIG. 15 is a schematic diagram showing a calculation apparatus 200 as a second embodiment of the present invention.

As shown in the figure, the calculation apparatus 200 comprises a storage part 210, a control part, an input part 230, an output part 140 and a sending/receiving part 150. Since the storage part 210, the control part 220 and the input part 230 are different from the ones in the first embodiment, these differences will be described below.

The storage part 210 in the present embodiment comprises a part information storage area 111, a lead time information storage area 112, an initial stock information storage area 113, an incoming-stock information storage area 114, a production plan information storage area 215 and a display information storage area 216. The part information storage area 111, the lead time information storage area 112, the initial stock information storage area 113 and the incoming-stock information storage area are the same as in the first embodiment, and their explanation is omitted here.

The production plan information storage area 215 in the present embodiment also stores information that specifies a production plan generated by the below-described producible quantity calculation part 221. In the first embodiment, a production plan table 115a is generated for each postponing method and stored in the production plan information storage area 215. In the present embodiment, a production plan table 115a is generated for each piece of production request information and stored in the production plan information storage area 215.

Also in the present embodiment, the form of each production plan table 115a is similar to the one of the first embodiment, and its description is omitted.

The display information storage area 216 in the present embodiment also stores display information generated by the below-described display information generation part 222. Here, the display information displays, in a table, information that specifies the producible quantities calculated for each product according to pieces of production request information described below.

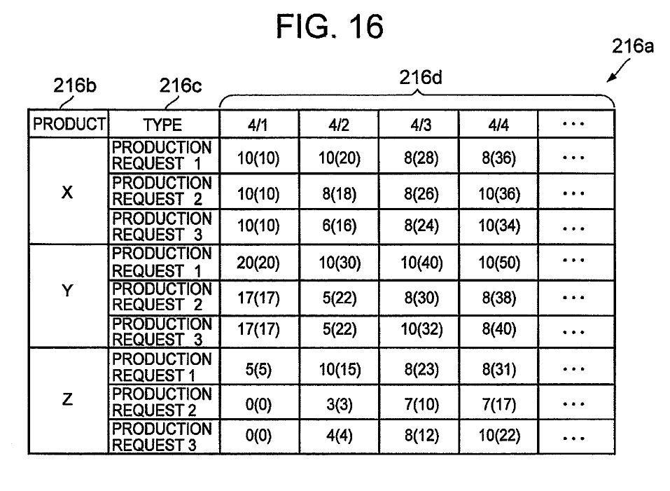

For example, the display information storage area 216 in the present embodiment stores information that specifies a display image 216a as shown in FIG. 16 (a schematic view showing the display image 216a).

Similarly to the first embodiment, a display image 216a in the present embodiment has a product field 216b, a type field 216c and a production plan field 216d.

The product field 216b stores identification information that identifies a product. Here, a name of a product is stored as the identification information.

The type field 216c stores identification information that identifies a production request or a postponing method. In the present embodiment, a character string “Production Request n” is stored for the n-th piece of production request information (n is a natural number as an identification number for identifying a piece of production request information) among pieces of production request information.

The production plan field 216d stores quantities producible by respective dates. Numbers in parentheses shown in the production plan field 216d indicate cumulative quantities.

The control part 220 comprises a producible quantity calculation part 221 and a display information generation part 222.

The producible quantity calculation part 221 performs MRP processing or postponement processing on the basis of production request information acquired through the below-described input part 130 or the sending/receiving part 150.

In the present embodiment, MRP processing or postponement processing is performed for each piece of production request information. Particularly, in the present embodiment, when the priority order is changed with each piece of production request information, it is possible to refer to production plans for various kinds of priority order.

Each method of the MRP processing or postponement processing is similar to the first embodiment, and its description is omitted. In the present embodiment, however, the postponement processing is performed according to one predetermined method.

The display information generation part 222 generates a display image 216a as shown in FIG. 16 from a production plan table 115a (stored in the production plan information storage area 215) generated by the producible quantity calculation part 121 on the basis of each piece of production request information. The generated display image 216a is stored in the display information storage area 216.

The display information generation part 222 also performs processing of outputting the generated display image 216a to the output part 140 in response to a request of the operator of the calculation apparatus 200 for example. Further, the display information generation part 222 also performs processing of sending the display image 216a through the sending/receiving part 150 for example.

The input part 230 is an input unit for inputting information. In the first embodiment, the production request information and the method information are inputted. In the present embodiment, pieces of production request information are inputted. Particularly, when priority order of production requests is changed with each piece of production request, it is possible to refer to production plans for various kinds of priority order.

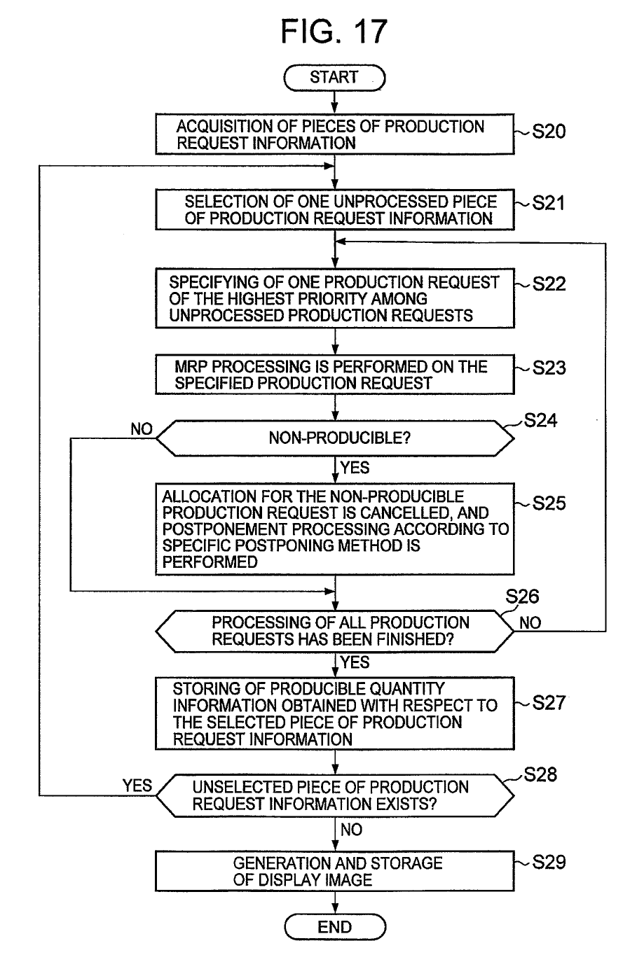

Processing performed by the calculation apparatus 200 of the above-described configuration will be explained referring to the flowchart shown in FIG. 17.

First, the calculation apparatus 200 acquires pieces of production request information through the input part 230 (S20).

Next, the producible quantity calculation part 221 of the calculation apparatus 200 selects one piece of unprocessed production information out of the pieces of production request information acquired in step S20 (S21).

Next, the producible quantity calculation part 221 of the calculation apparatus 200 specifies one production request having the highest priority among unprocessed production requests from the production request information selected in step S21 (S22).

The producible quantity calculation part 221 of the calculation apparatus 200 performs the MRP processing on the production request specified in step S22 (S23). If the designated requested quantity of the product cannot be produced by the designated requested date (S24), the processing flow proceeds to step S25. If the production request is judged to be producible, the processing flow proceeds to step S26.

In step S25, the allocation for the production request judged to be non-producible is cancelled. The producible quantity calculation part 221 of the calculation apparatus 200 performs the postponement processing according to the predetermined postponing method (S25).

In step S26, the producible quantity calculation part 221 of the control part 220 checks whether the processing of all the production requests in the production request information selected in step S21 has been finished or not. If the processing of all the production requests has not been finished, the processing flow returns to step S22 to repeat the processing.

If it is judged, in step S26, that the processing of all the production requests has been finished, then the producible quantity calculation part 221 of the control part 220 tabulates the calculated production plan into the production plan table 115a, and stores the production plan table 115a in the production plan information storage area 215 (S27).

The producible quantity calculation part 221 of the control part 220 judges whether there is an unselected piece among the pieces of production request information acquired in step S20 (S28).

When it is judged, in step S28, that an unselected piece of production request information exists, then the processing flow returns to step S21 to repeat the processing. On the other hand, when it is judged that no unselected piece of production request information exists, then the display information generation part 222 of the control part 220 generates a display image 216a from the production plan table 115a, and stores the generated display image 216a in the display information storage area 216 (S29).

The display image 216a stored in this way can be outputted to the output part 140 or sent to another apparatus through the sending/receiving part 150, so that the display image 216a can be seen, for example, through a display or the like.

Since the display image 216a specifies production plans (producible quantities) according to pieces of production request information (priority order), it is possible to perform production according to a suitable production plan.

In the second embodiment, particularly the priority order is changed with each piece of production request information, so that it is possible to perform production according to a suitable production plan. This mode, however, is not restrictive. For example, in the first embodiment, the priority order specified in the production request information can be changed randomly or according to a specific rule (for example, exchange of adjacent production requests) in order that various production plans can be referred to.

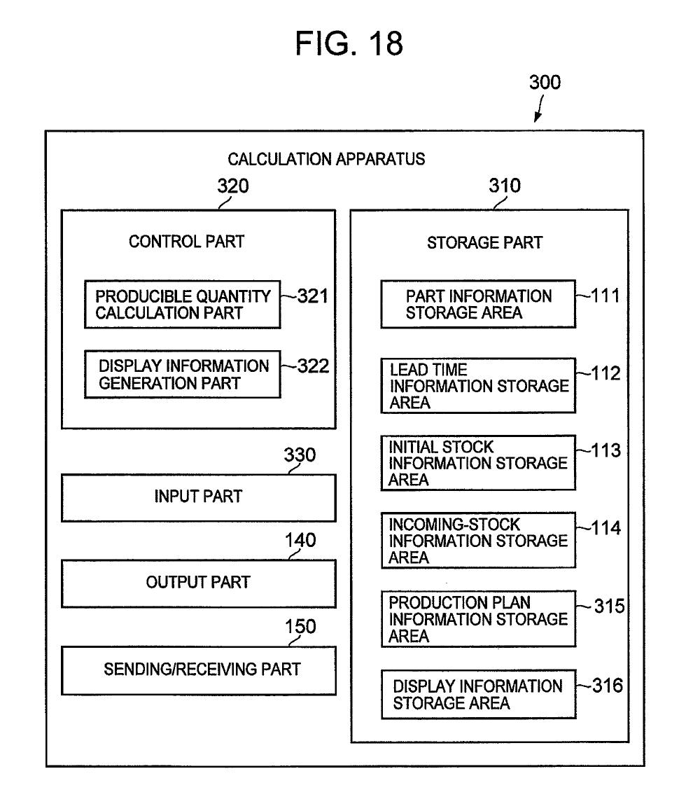

FIG. 18 is a schematic diagram showing a calculation apparatus 300 as a third embodiment of the present invention.

As shown in the figure, the calculation apparatus 300 comprises a storage part 310, a control part 320, an input part 330, an output part 140 and a sending/receiving part 150. In comparison with the first embodiment, since the storage part 310, the control part 320 and the input part 330 are different, these differences will be described below.

The storage part 310 of the present embodiment comprises a part information storage area 111, a lead time information storage area 112, an initial stock information storage area 113, an incoming-stock information storage area 114, a production plan information storage area 315 and a display information storage area 316. The part information storage area 111, the lead time information storage area 112, the initial stock information storage area 113 and the incoming-stock information storage area 114 are similar to the first embodiment, and their description is omitted.

The production plan information storage area 315 of the present embodiment also stores information that specifies a production plan generated by the below-described producible quantity calculation part 321. In the first embodiment, a production plan table 115a is generated for each postponing method and stored in the production plan information storage area 215. In the present embodiment, a production plan table 115a is generated for each method and for each piece of production request information, and stored in the production plan information storage area 315.

Also in the present embodiment, the form of each production plan table 115a is similar to the one of the first embodiment, and its description is omitted.

The display information storage area 316 in the present embodiment also stores display information generated by the below-described display information generation part 322. Here, the display information displays, in a table, information that specifies the producible quantities calculated for each product according to pieces of production request information described below.

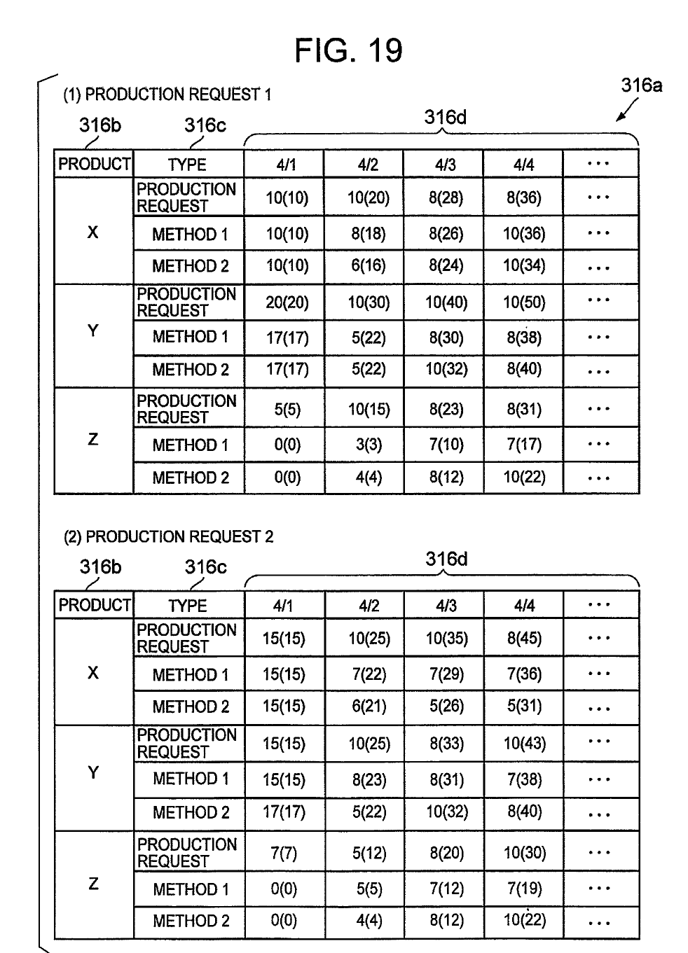

For example, the display information storage area 316 in the present embodiment stores information that specifies a display image 316a as shown in FIG. 19 (a schematic view showing the display image 316a).

The display image 316a in the present embodiment has a product field 316b, a type field 316c and a production plan field 316d, for each production request. Information stored in each field is similar to the first embodiment, and its description is omitted.

The control part 320 comprises a producible quantity calculation part 321 and a display information generation part 322.

The producible quantity calculation part 321 performs MRP processing or postponement processing on the basis of pieces of production request information and method information acquired through the below-described input part 330 or sending/receiving part 150.

Each method of the MRP processing or postponement processing is similar to the first embodiment, and its description is omitted. In the present embodiment, however, postponement processing is performed with respect to pieces of production request information according to a plurality of postponing methods designated in the method information.

The display information generation part 222 generates display images 316a as shown in FIG. 19 from a production plan table 115a (stored in the production plan information storage area 315) generated by the producible quantity calculation part 121 on the basis of each piece of production request information, and stores the generated display images 316a in the display information storage area 316.

The display information generation part 222 also performs processing of outputting the display images 316a to the output part 140 in response to a request of the operator of the calculation apparatus 300 for example. Further, the display information generation part 222 also performs processing of sending the display images 316a through the sending/receiving part 150 for example.

The input part 330 is an input unit for inputting information. In the present embodiment, pieces of production request information and method information are inputted.

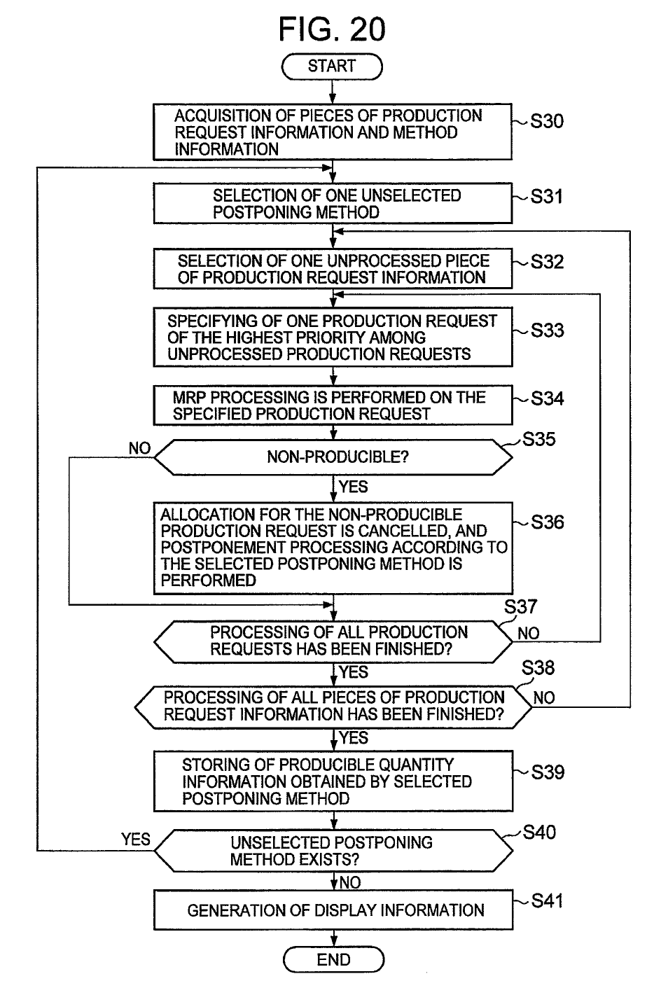

Processing performed by the calculation apparatus 300 of the above-described configuration will be explained referring to the flowchart shown in FIG. 20.

First, the calculation apparatus 300 acquires pieces of production request information and method information through the input part 330 (S30).

Next, the producible quantity calculation part 321 of the calculation apparatus 300 selects one unselected postponing method among the postponing methods included in the method information acquired in step S30 (S31).

Further, the producible quantity calculation part 321 of the calculation apparatus 300 selects one unprocessed piece of production request information among the pieces of production request information acquired in step S30 (S32).

Next, the producible quantity calculation part 321 of the calculation apparatus 300 specifies one unprocessed production request having the highest priority among the unprocessed production requests on the basis of the piece of production request information selected in step S32 (S33).

The producible quantity calculation part 321 of the calculation apparatus 300 performs the MRP processing on the production request specified in step S33 (S34). If the designated requested quantity of a product cannot be produced by the designated requested date (S35), the processing flow proceeds to step S36. If the production request is judged to be producible, the processing flow proceeds to step S37.

In step S36, the allocation for the production request judged to be non-producible is cancelled. The producible quantity calculation part 321 of the calculation apparatus 300 performs the postponement processing according to the postponing method selected in step S31 (S36).

In step S37, the producible quantity calculation part 321 of the control part 320 checks whether the processing of all the production requests in the piece of production request information selected in step S32 has been finished or not. If the processing of all the production requests has not been finished, the processing flow returns to step S33 to repeat the processing.

If it is judged, in step S37, that the processing of all the production requests has been finished, the processing flow proceeds to step S38.

In step S38, the producible quantity calculation part 321 of the control part 320 checks whether the processing of all the pieces of production request information acquired in step S30 has been finished or not. If the processing of all the pieces of production request information has not been finished, the processing flow returns to step S32 to repeat the processing.

If it is judged, in step S38, that the processing of all the pieces of production request information has been finished, then the processing flow proceeds to step S39.

In step S39, the producible quantity calculation part 321 of the control part 320 tabulates the calculated production plans into the production plan tables 115a, and stores the production plan tables 115a in the production plan information storage area 315.

The producible quantity calculation part 321 of the control part 320 judges whether there is an unselected method among the postponing methods included in the method information acquired in step S20 (S40).

When it is judged, in step S40, that an unselected postponing method exists, then the processing flow returns to step S31 to repeat the processing. On the other hand, when it is judged that no unselected postponing method exists, then the display information generation part 322 of the control part 320 generates the display images 316a from the production plan tables 115a, and stores the generated display images 316a in the display information storage area 316 (S41).

The display images 316a stored in this way can be outputted to the output part 140 or sent to another apparatus through the sending/receiving part 150, so that the display images 316a can be seen through a display or the like for example.

Since the display images 316a specify production plans (producible quantities) according to pieces of production request information and a plurality of methods, it is possible to perform production according to a suitable production plan.

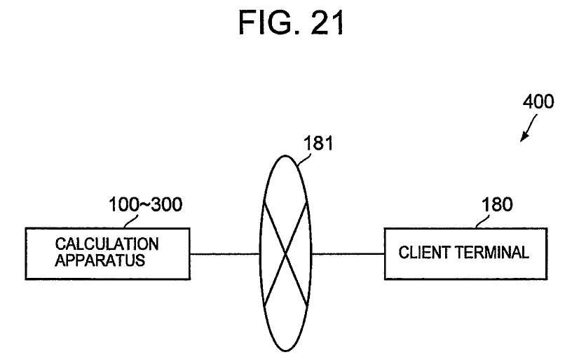

Each of the calculation apparatuses 100, 200 and 300 of the above-described configurations can be used in a calculation system 400 shown in FIG. 21 (a schematic block diagram showing the calculation system 400).

The calculation system 400 comprises a calculation apparatus 100-300 and a client terminal 180. The calculation apparatus 100-300 and the client terminal 180 can send and receive information to and from each other through a network 181.

In the calculation system of this configuration, the client terminal 180 can send production request information and method information to the calculation apparatus 100-300. The calculation apparatus 100-300 can calculate producible quantities and return a generated display image to the client terminal 180.

The client terminal 180 also can be implemented by a computer 170 as shown in FIG. 13.

1. A calculation apparatus which performs Material Requirements Planning by receiving production request information that has at least one production request specifying a requested production quantity of a product, a requested production date, and a priority, to obtain a producible quantity and a possible production date according to the priority, with respect to the production request information, wherein:
the calculation apparatus comprises a control part that performs:
postponement processing, in which, in the Material Requirements Planning, if it is judged that a requested production quantity in one production request cannot be produced by the requested production date in the one production request, a plurality of methods of changing the requested production date to a later date are determined in advance, and the Material Requirements Planning is performed with the requested production date of the one production request changed to the later date according to the plurality of methods, and processing of changing a requested production date in the one production request to a later date is repeated until all the requested production quantities in the one production request can be produced; and
processing of generating image data that display, in a table, the producible quantities and the possible production dates calculated by the postponement processing for each of the methods with respect to the production request information.

2. A calculation apparatus of claim 1, wherein:
a first method of the plurality of methods is one in which a new production request, having a priority following the priority of the one production request, is generated, and the requested production date in the one production request is sequentially postponed until the requested production quantity judged to be non-producible in the one production request becomes producible at the following priority.

3. A calculation apparatus of claim 1, wherein:
a second method of the plurality of methods is one in which a new production request, having a highest priority among production requests of a requested date following the requested production date of the one production request, is generated, and the requested production date and the priority of the one production request are, respectively, sequentially postponed and given a sequentially lower priority, until the requested production quantity, judged to be non-producible in the one production request, becomes producible.

4. A calculation apparatus which performs Material Requirements Planning by receiving production request information that has at least one production request specifying a requested production quantity of a product, a requested production date and a priority, to obtain a producible quantity and a possible production date according to the priority, with respect to the production request information, wherein:
the calculation apparatus comprises a control part that performs:
processing of calculating a plurality of producible quantities and a plurality of possible production dates by changing priority order in the production request information, to perform Material Requirements Planning; and
processing of generating image data that display, in a table, the plurality of producible quantities and the plurality of possible production dates.

5. A calculation apparatus of claim 4, further comprising:
an input part for inputting the production request information; wherein
the control part receives, through the input part, plural pieces of production request information whose priority order is changed, and performs the Material Requirements Planning based on the received plural pieces of production request information, to calculate a plurality of producible quantities and a plurality of possible production dates.

6. A program that makes a computer perform Material Requirements Planning by receiving production request information that has at least one production request specifying a requested production quantity of a product, a requested production date, and a priority, to obtain a producible quantity and a possible production date according to the priority, with respect to the production request information, wherein:
the program makes a control means of the computer perform:
postponement processing, in which, in the Material Requirements Planning, if it is judged that a requested production quantity in one production request cannot be produced by the requested production date in the one production request, a plurality of methods of changing the requested production date to a later date are determined in advance, and the Material Requirements Planning is performed with the requested production date of the one production request changed to the later date according to the plurality of methods, and processing of changing a requested production date in the one production request to a later date is repeated until all the requested production quantities in the one production request can be produced; and
processing of generating image data that display, in a table, the producible quantities and the possible production dates calculated by the postponement processing for each of the methods with respect to the production request information.

7. A program of claim 6, wherein:
a first method of the plurality of methods is one in which a new production request, having a priority following the priority of the one production request, is generated, and the requested production date in the one production request is sequentially postponed until the requested production quantity judged to be non-producible in the one production request becomes producible at the following priority.

8. A program of claim 6, wherein:
a second method of the plurality of methods is one in which a new production request having a highest priority among production requests of a requested date following the requested production date of the one production request is generated, and the requested production date and the priority of the one production request are, respectively, sequentially postponed and given a sequentially lower priority, until the requested production quantity, judged to be non-producible in the one production request, becomes producible.

9. A program that makes a computer perform Material Requirements Planning by receiving production request information that has at least one production request specifying a requested production quantity of a product, a requested production date and a priority, to obtain a producible quantity and a possible production date according to the priority, with respect to the production request information, wherein:
the program makes a control means of the computer perform:
processing of calculating a plurality of producible quantities and a plurality of possible production dates by changing priority order in the production request information, to perform Material Requirements Planning; and
processing of generating image data that display, in a table, the plurality of producible quantities and the plurality of possible production dates.

10. A program of claim 9, wherein:
the program makes the control means perform:
processing in which the plural pieces of production request information having the changed priority order are received through an input means of the computer; and
processing in which the Material Requirements Planning is performed based on the plural pieces of production request information received through the input means, to calculate a plurality of producible quantities and a plurality of possible production dates.

11. A calculation system in which:
a client terminal sends production request information that has at least one production request specifying a requested production quantity of a product, a requested production date, and a priority, to a calculation apparatus; and
the calculation apparatus performs Material Requirements Planning for obtaining a producible quantity and a possible production date with respect to the production request information received from the client terminal and according to the priority;
wherein the calculation apparatus comprises a control part that performs:
postponement processing, in which, in the Material Requirements Planning, if it is judged that a requested production quantity in one production request cannot be produced by the requested production date in the one production request, a plurality of methods of changing the requested production date to a later date are determined in advance, and the Material Requirements Planning is performed with the requested production date of the one production request changed to the later date according to the plurality of methods, and processing of changing a requested production date in the one production request to a later date is repeated until all the requested production quantities in the one production request can be produced;
processing of generating image data that display, in a table, the producible quantities and the possible production dates calculated by the postponement processing for each of the methods with respect to the production request information; and
processing of sending the image data to the client terminal.

12. A calculation system of claim 11, wherein:
a first method of the plurality of methods is one in which a new production request, having a priority following the priority of the one production request, is generated, and the requested production date in the one production request is sequentially postponed until the requested production quantity judged to be non-producible in the one production request becomes producible at the following priority.

13. A calculation system of claim 11, wherein:
a second method of the plurality of methods is one in which a new production request having a highest priority among production requests of a requested date following the requested production date of the one production request is generated, and the requested production date and the priority of the one production request are, respectively, sequentially postponed and given a sequentially lower priority, until the requested production quantity judged to be non-producible in the one production request becomes producible.

14. A calculation system in which:
a client terminal sends production request information that has at least one production request specifying a requested production quantity of a product, a requested production date, and a priority, to a calculation apparatus;
the calculation apparatus performs Material Requirements Planning for obtaining a producible quantity and a possible production date with respect to the production request information received from the client terminal and according to the priority;
wherein the calculation apparatus comprises a control part that performs:
processing of calculating a plurality of producible quantities and a plurality of possible production dates by changing priority order in the production request information, to perform Material Requirements Planning;
processing of generating image data that display, in a table, the plurality of producible quantities and the plurality of possible production dates; and
processing of sending the image data to the client terminal.

15. A calculation system of claim 14, wherein:
the client terminal sends plural pieces of production request information, having the changed priority order, to the calculation apparatus; and
the control part of the calculation apparatus performs the Material Requirements Planning based on the plural pieces of production request information received from the client terminal, to calculate a plurality of producible quantities and a plurality of possible production dates.

16. A calculation method in a calculation apparatus that comprises a control part performing Material Requirements Planning by receiving production request information that has at least one production request specifying a requested production quantity of a product, a requested production date, and a priority, to obtain a producible quantity and a possible production date according to the priority, with respect to the production request information, wherein:
the calculation method comprises:
a postponement processing step, in which, in the Material Requirements Planning, if the control part judges that a requested production quantity in one production request cannot be produced by the requested production date in the one production request, a plurality of methods of changing the requested production date to a later date are determined in advance, and the control part performs the Material Requirements Planning with the requested production date of the one production request changed to the later date according to the plurality of methods, and the control part repeats processing of changing a requested production date in the one production request to a later date until all the requested production quantities in the one production request can be produced; and
an image data generation processing step, in which the control part generates image data that display, in a table, the producible quantities and the possible production dates calculated by the postponement processing for each of the methods with respect to the production request information.
